(19) United States
(12) Patent Application Publication
(10) Pub. No.: US 2022/0062843 A1
(43) Pub. Date: Mar. 3, 2022

(54) METHODS AND SYSTEMS FOR ELIMINATING ENVIRONMENTAL CONTAMINANTS USING BIOMASS

(71) Applicant: The Research Foundation for the State University of New York, Albany, NY (US)

(72) Inventors: Yanna Liang, Slingerlands, NY (US); Weilan Zhang, Albany, NY (US)

(21) Appl. No.: 17/466,008

(22) Filed: Sep. 3, 2021

Related U.S. Application Data
(60) Provisional application No. 63/074,244, filed on Sep. 3, 2020.

(51) Int. Cl. B01J 6/00; C01B 32/05; C10G 3/00

(52) U.S. Cl. CPC B01J 6/00; C01B 32/05; C10G 2300/201; C10G 2300/1014; C10G 3/44

(57) ABSTRACT

Methods for eliminating environmental contaminants using biomass are disclosed. The methods may include combining at least a portion of a biomass and a solvent within a reactor of a hydrothermal liquefaction system, where at least the portion of the biomass having absorbed and includes an environmental contaminant. The method may also include heating the combination of at least the portion of the biomass and the solvent under predetermined operational characteristics, and generating a plurality of byproducts free of the environmental contaminant.

### CROSS-REFERENCE TO RELATED APPLICATIONS

This application claims priority to U.S. provisional application No. 63/074,244 filed on Sep. 3, 2020, the content of which is hereby incorporated by reference into the present application.

### BACKGROUND

The disclosure relates generally to the elimination and destruction of environmental contaminants, and more particularly, to methods and systems for eliminating environmental contaminants using biomass and portions of biomass that absorb the contaminants.

Poly- and perfluoroalkyl substances (PFAS) are persistent anthropogenic compounds that have been widely used since the 1950s and are now ubiquitously detected in the environment from the atmosphere to the biosphere and to the hydrosphere. Across the United States, hundreds of sites have been contaminated by PFAS, and more than 6 million Americans are consuming water containing perfluorooctanesulfonic acid (PFOS) and perfluorooctanoic acid (PFOA) exceeding the US EPA's provisional guidelines for these two chemicals, a maximum combined 70 ng/L. Many adverse health effects for humans and wildlife, including cancer, obesity, immunotoxicity, and thyroid disease, have been associated with exposures to PFAS.

A wide range of technologies has been explored over the years for removing PFAS from contaminated environments. The conventional approach investigated most extensively is sorption. A broad range of sorbents, such as activated carbon (AC), ion exchange resins, minerals, carbon nanotubes, biochar, and molecularly imprinted polymers have been tested for use in PFAS removal from different environmental media. Besides sorption, other conventional techniques, including coagulation and flocculation, membrane filtration, chemical reactions, and biodegradation are still at different research stages.

Despite the fact that sorption has been used at commercial scales for removing PFAS from drinking water and groundwater, it is not without drawbacks. First, generating AC or resins from different feedstocks is energy consuming. Second, the spent media, after regeneration or reactivation, must be replaced and/or shipped off-site for disposal through landfilling or commercial incineration at 600-1000° C. Third, the sorption process is generally conducted in engineered vessels that are not inexpensive to build and maintain. Fourth, the breakthrough times for PFAS with five carbon atoms or shorter are less than those for longer chain PFAS. As a consequence, the removal efficiency of shorter chain PFAS is affected negatively, and this creates a need of frequent sorbent changeout. Fifth, when multiple PFAS are present in the influent, sorbent's selective removal allows some PFAS to appear in the effluent without much treatment.

### BRIEF DESCRIPTION

A first aspect of the disclosure provides a method including: combining at least a portion of a biomass and a solvent within a reactor of a hydrothermal liquefaction system, at least the portion of the biomass having absorbed and including an environmental contaminant; heating the combination of at least the portion of the biomass and the solvent under predetermined operational characteristics; and generating a plurality of byproducts free of the environmental contaminant.

A second aspect of the disclosure provides a hydrothermal liquefaction system. The system including: a reactor, the reactor receiving: a solvent, and at least a portion of a biomass having absorbed and including an environmental contaminant; a heating source positioned within or adjacent the reactor, the heating source heating the reactor including a combination of the solvent and at least the portion of the biomass received therein; and a control system electrically coupled to the reactor and the heating source, the control system configured to eliminate the environmental contaminant from at least the portion of the biomass by performing processes including: heating the combination of at least the portion of the biomass and the solvent under predetermined operational characteristics via the heating source.

The illustrative aspects of the present disclosure are designed to solve the problems herein described and/or other problems not discussed.

### BRIEF DESCRIPTION OF THE DRAWINGS

These and other features of this disclosure will be more readily understood from the following detailed description of the various aspects of the disclosure taken in conjunction with the accompanying drawings that depict various embodiments of the disclosure, in which:

FIGS. 1A and 1B show front views of an environment including biomasses and environmental contaminants, according to embodiments of the disclosure.

FIG. 2 shows a schematic view of a hyperthermal liquefaction system for processing the biomasses of FIGS. 1A and 1B to eliminate the environmental contaminants, according to embodiments of the disclosure.

FIG. 3 shows a flowchart illustrating a process for eliminating environmental contaminants using biomasses, according to embodiments of the disclosure.

It is noted that the drawings of the disclosure are not to scale. The drawings are intended to depict only typical aspects of the disclosure, and therefore should not be considered as limiting the scope of the disclosure. In the drawings, like numbering represents like elements between the drawings.

### DETAILED DESCRIPTION

As an initial matter, in order to clearly describe the current disclosure it will become necessary to select certain terminology when referring to and describing relevant components within the disclosure. When doing this, if possible, common industry terminology will be used and employed in a manner consistent with its accepted meaning. Unless otherwise stated, such terminology should be given a broad interpretation consistent with the context of the present application and the scope of the appended claims. Those of ordinary skill in the art will appreciate that often a particular component may be referred to using several different or overlapping terms. What may be described herein as being a single part may include and be referenced in another context as consisting of multiple components. Alternatively, what may be described herein as including multiple components may be referred to elsewhere as a single part.

As discussed herein, the disclosure relates generally to elimination and destruction of environmental contaminants, and more particularly, to methods and systems for eliminating the environmental contaminants using biomass and portions of biomass that absorb the contaminants.

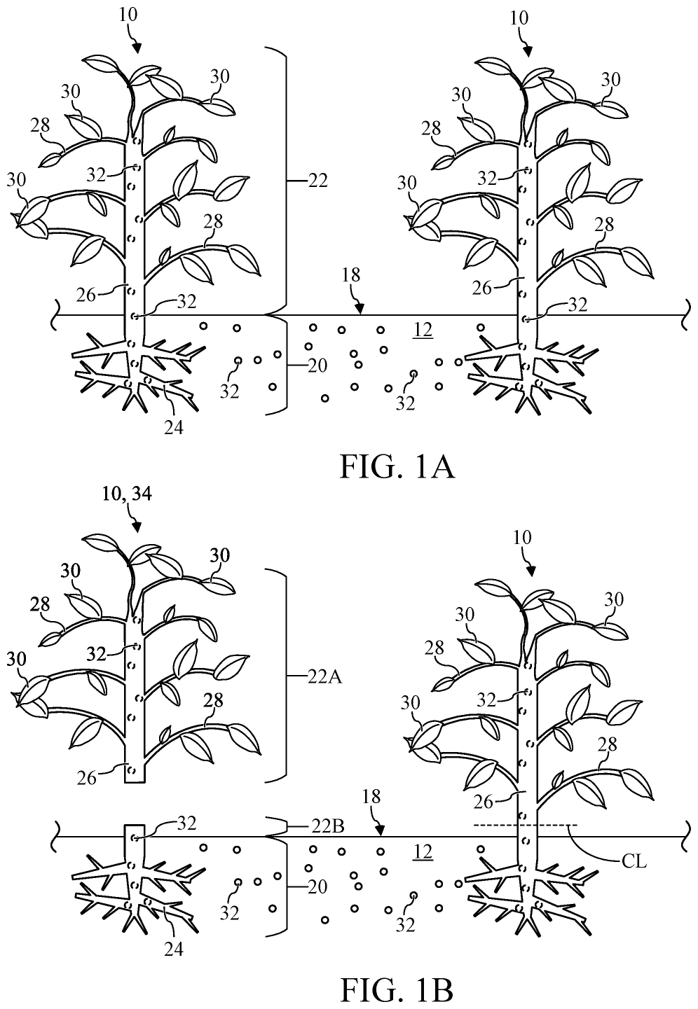

These and other embodiments are discussed below with reference to FIGS. 1A-3. However, those skilled in the art will readily appreciate that the detailed description given herein with respect to these Figures is for explanatory purposes only and should not be construed as limiting.

Turning to FIGS. 1A and 1B, biomasses 10 of an environment 12 is shown. More specifically, environment 12 including a plurality of biomasses 10 planted, positioned, or included within environment 12 is shown. In a non-limiting example biomass 10 may be formed as a plant extending above and below a surface 18 of environment 12. That is, biomass 10 may extending and/or grow below surface 18 of environment 12, as well as grow and/or extend upwards or away from surface 18, to be exposed to an ambient atmosphere surrounding environment 12. Biomass 10 may be formed as any suitable multicellular organism and/or photosynthetic eukaryotes classified in the kingdom Plantae. For example, biomass 10 may be formed as, but is not limited to, Juncus effusus, Typha latifolia (cattail), Phragmites australis (common reed), and/or a variety of wetland plants. Biomass 10 may be naturally occurring within environment 12, may be purposefully planted or grown within environment 12, and/or may be formed or positioned (e.g., not grown) within environment 12 for a predetermined amount of time in order to absorb environmental contaminants from environment 12, as discussed herein. In the non-limiting example shown in FIGS. 1A and 1B, environment 12 may include soil or earth having an exposed surface 18 (e.g., ground). In other non-limiting examples, environment 12 may be formed as a body of water, where surface 18 represents the surface of the water. In this non-limiting example, environment 12 may include a lake, pond, river, sea, marsh, reservoir, and other suitable body of water. As used throughout, it is understood that “biomass” and “plant” may be used interchangeably. However, the process discussed herein that may utilize “biomasses” is not limited to just plants, but any biomass that may absorb environmental contaminants.

As shown in FIGS. 1A and 1B, biomass 10 formed as a plant, may include a plurality of systems or portions. For example, the plant forming biomass 10 may include a root system 20 and a shoot system 22 formed integral with and adjacent root system 20. Root system 20 of biomass 10 may be positioned, formed, and/or grow within environment 12, below surface 18. Distinctly, shoot system 22 formed integral with root system 20 may be positioned and/or grow above surface 18 of environment 12. That is, root system 20 may be defined as the portion of biomass 10 formed below surface 18, while shoot system 22 may be defined as the portion of biomass 10 that may be positioned above surface 18. Root system 20 of biomass 10 may include a plurality of roots 24 embedded within, extending through, and/or growing in environment 12.

Shoot system 22 of biomass 10 may include a plurality of parts. The parts included in shoot system 22 may be dependent, at least in part, on the type of plant forming biomass 10 (e.g., flowering plant, fruit plant, seed plant). In the non-limiting example shown in FIGS. 1A and 1B, shoot system 22 of biomass 10 may include a stem 26. Stem 26 may extend from roots 24 and/or root system 20. Additionally or alternatively, a portion of stem 26 may also extend into root system 20 and/or environment 12. Also in the non-limiting example, shoot system 22 may include a plurality of nodes 28 extending from stem 26 and leaves 30 formed or grown on nodes 28. In other non-limiting examples, shoot system 20 of biomass 10 may include flowers and/or fruit (not shown) growing from nodes 28 and/or leaves 30.

Environment 12 may also include environmental contaminants 32. More specifically, environment 12 and biomass 10 may include environmental contaminants 32 included, formed, positioned, and/or absorbed thereon. As a result of environmental contaminants 32 being included and absorbed by biomass 10 and environment 12, the composition of each of biomass 10 and environment 12 may include environmental contaminants 32 as well. That is, overtime and due to exposure to and/or leeching of environmental contaminants 32, both biomass 10 and environment 12 may be contaminated with environmental contaminants 32. In a non-limiting example, environmental contaminants 32 may be present in biomass 10 and environment 12 due to natural occurrence of environmental contaminants 32 and/or manufactures/man-made contaminants. The cause for contamination of biomass 10 and environment 12 may be dependent, at least in part on the type or composition of environmental contaminant 32. For example, environmental contaminants 32 may include, but are not limited to, polyfluoroalkyl or perfluoroalkyl substance (PFAS), ether PFAS, precursors to perfluoroalkyl acids (PFAAs), perfluorooctane-sulfonic acid (PFOS), perfluorooctanoic acid (PFOA), perfluorocarboxylic acids (PFCAs) and/or perfluorosulfonic acids (PFSAs). Although discussed herein as “environmental contaminants,” it is understood that environmental contaminants 32 may be any contaminant that may be present and absorbed within biomass 10 and/or environment 12.

As discussed herein, biomass 10 may also include environmental contaminants 32. That is, and based on the connection, plant-growth process, and/or environmental communication (e.g., roots 24 absorbing water from environment 12) between biomass 10 and environment 12, biomass 10 may include, absorb, and/or be molecularly composed of environmental contaminants 32. As shown in FIG. 1A, root system 20 and shoot system 22 of biomass 10 may include environmental contaminants 32. In a non-limiting example, biomass 10 may absorb and/or include environmental contaminants 32 as a result of a phytoremediation process.

Environmental contaminants 32 may be removed from environment 12 using biomasses 10. More specifically, after biomasses 10 absorb environmental contaminants 32, biomasses 10 may be processed to remove, destroy, and/or eliminate environmental contaminants 32 therein, and as such, the process in turn removes, destroys, and/or eliminates environmental contaminants 32 from environment 12. In order to eliminate environmental contaminants 32, biomass 10 may first be harvested in preparation for elimination of environmental contaminants 32 included therein. In the non-limiting example shown in FIG. 1B, biomass 10 may be harvested to form a specimen 34 that includes at least a portion of shoot system 22A. That is, specimen 34 of biomass 10 may include at least a portion of shoot system 22A including stem 26, nodes 28, and leaves 30. In the non-limiting example shown in FIG. 1B, specimen 34 of biomass 10 may not include the entirety of shoot system 22. That is, and as shown, biomass 10 formed as plant may include a portion of shoot system 22B, and more specifically a portion of stem 26, that may remain in environment 12 to continue to grow and simultaneously absorb environmental contaminants 32. The growth of biomass 10 from the remaining portion of shoot system 22B may later be harvested to form another specimen 34, and undergo similar processes discussed herein to eliminate environmental contaminants 32 from biomass 10/environment 12. Specimen 34 may be formed by cutting, breaking, and/or sectioning biomass 10 along cut line (CL) as shown in FIG. 1B.

In another non-limiting example, specimen 34 may include the entirety of shoot system 22 of biomass 10. Additionally, or alternatively, specimen 34 may also include at least a portion of root system 20 for biomass 10. In yet another non-limiting example, specimen 34 may include the entirety of biomass 10 (e.g., all of root system 20 and shoot system 22). In still further examples, specimen 34 may only include root system 20, and upon harvesting, shoot system 22 of biomass 10 may be disposed of or replanted in environment 12 to form new root system 20 for future or subsequent harvesting to eliminate environmental contaminants 32 in biomass 10/environment 12.

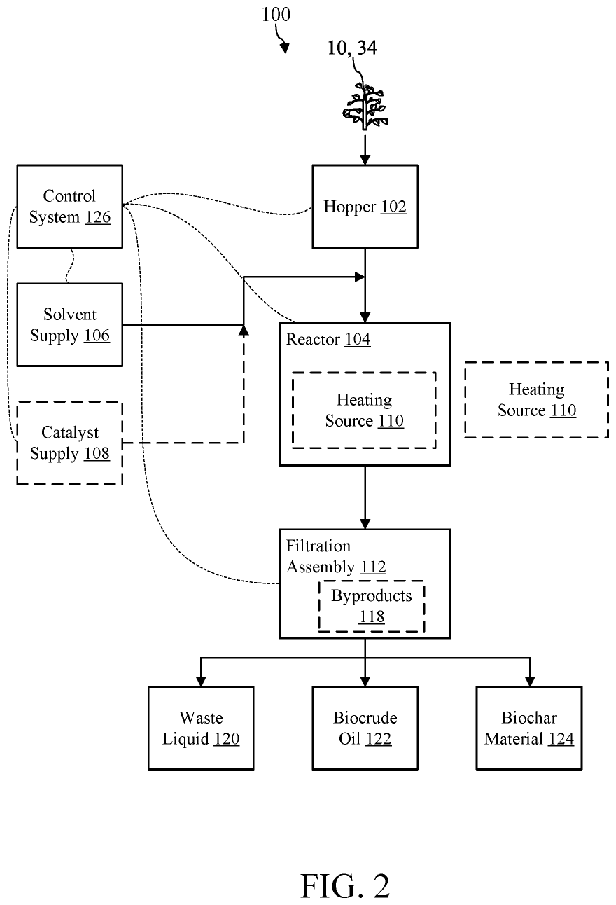

Turning to FIG. 2, a system 100 for eliminating environmental contaminants 32 from environment 12 is shown. In the non-limiting example, system 100 includes a hydrothermal liquefaction system capable of processing specimen 34 of biomass 10 to remove, destroy, and/or eliminate environmental contaminants 32 from biomass 10/environment 12. It is understood that similarly numbered and/or named components may function in a substantially similar fashion. Redundant explanation of these components has been omitted for clarity.

System 100 may include a hopper 102. Hopper 102 may receive, collect, and/or accept a plurality of harvested specimens 34 of biomass 10. That is, after being harvested, specimens 34 of biomass 10 may be feed and/or collected in hopper 102 in preparation for processing. Hopper 102 may also include additional components or internal systems (not shown) that may further process specimen 34. For example, hopper 102 may also include components to sort, grind, breakdown, and/or sieve specimen 34 of biomass 10. In other non-limiting examples, these components may be stand alone and may be formed downstream of hopper 102 of system 100. Hopper 102 may be formed of any suitable device or component capable of receiving specimen 34 of biomass 10 and subsequently providing specimens 34 to additional portions of system 100.

System 100 may also include a reactor 104, positioned downstream of hopper 102. More specifically, reactor 104 of system 100 may be positioned downstream and in communication with hopper 102. In a non-limiting example, reactor 104 may be formed as a sealed or sealable vessel that may receive specimen 34 of biomass 10, along with other material to process biomass 10, as discussed herein. The sealed vessel forming reactor 104 may be used in the process of heating and pressurizing specimen 34 of biomass 10 to eliminate environmental contaminants 32. Reactor 104 may be formed from any suitable vessel or container that may receive biomass 10 and perform the processes discussed herein for eliminating environmental contaminants 32 included within biomass 10.

A solvent supply 106 may be in fluid communication with reactor 104 of system 100. In the non-limiting example shown in FIG. 2, solvent supply 106 may be in communication with a conduit extending between and coupling hopper 102 and reactor 104. In other non-limiting examples solvent supply 106 may be in direct communication with reactor 104 via a conduit. Solvent supply 106 may supply a solvent material to be added to specimens 34 of biomass 10 to aid in the elimination of environmental contaminants 32. The solvent supplied by solvent supply 106 may be combined with biomass 10 prior to undergoing processes (e.g., heating, pressurization) within reactor 104. The supplied solvent may be any suitable material that may aid in the breakdown or elimination of environmental contaminants 32 included or absorbed into biomass 10. In an non-limiting example, solvent may be water, or alternatively may include water and other co-solvents, such as ethanol/methanol.

System 100 may also include a catalyst supply 108, shown in phantom as optional. Catalyst supply 108 may be in fluid communication with reactor 104 of system 100. In the non-limiting example, catalyst supply 108 may be in communication with a conduit extending between and coupling solvent supply 106 and reactor 104. In other non-limiting examples catalyst supply 108 may be in direct communication with reactor 104 via a conduit. catalyst supply 108 may supply a catalyst material to be added to the solvent material (e.g., water) supplied by solvent supply 106 to aid in the elimination of environmental contaminants 32. Catalyst supplied by catalyst supply 108 may be mixed with the supplied solvent and biomass 10 prior to undergoing processes (e.g., heating, pressurization) within reactor 104. Alternatively, the supplied catalyst material may be mixed with the solvent first, and the combination of the solvent and the catalyst may be mixed or combined with specimens 34 of biomass 10. The catalyst may be any suitable material that may aid in the breakdown or elimination of environmental contaminants 32 included or absorbed into biomass 10. In non-limiting examples, catalyst may be calcium hydroxide (Ca(OH)₂), potassium hydroxide (KOH), sodium hydroxide (NaOH), or metal material (e.g., iron (FE)) having distinct particle sizes (e.g., nanometer or micrometer).

As shown in FIG. 2, system 100 may also include a heating source 110. In one non-limiting example, heating source 110 may be positioned directly within reactor 104. In another non-limiting example, heating source 110 may be positioned adjacent to and/or outside of reactor 104 and/or the vessel forming reactor 104 that receives the combination of biomass 10 and the solvent (and catalyst when applicable). Heating source 110 may be configured to heat the combination of biomass 10 and solvent positioned within the vessel of reactor 104. As discussed herein, the heating, along with the pressurization, of the combination of specimens 34 of biomass 10 and solvent may eliminate environmental contaminants 32 included within biomass 10 that may be absorbed from environment 12. Heating source 110 may be any suitable device, system, assembly, and/or component that may be capable of heating reactor 104 and the content included therein to eliminate environmental contaminants 32 from biomass 10, and in turn environment 12.

A filtration assembly 112 of system 100 may be positioned downstream from reactor 104. More specifically, filtration assembly 112 may be positioned downstream and in fluid communication with reactor 104. Filtration assembly 112 may receive a plurality of byproducts 118 generated or created within reactor 104 after performing environmental contaminants 32 elimination processes, as discussed herein. The plurality of byproducts 118 may be free of environmental contaminants 32. That is, the elimination process performed by and/or within reactor 104 may result in the destruction, removal, and/or elimination of contaminants 32 in specimens 34 of biomass 10. Filtration assembly 112 may receive byproducts 118 and filter, separate, and/or isolate each byproduct 118. In an non-limiting example, filtration assembly 112 may separate byproducts 118 from reactor 104 into waste liquid 120, biocrude oil 122, and biochar material 124. As discussed herein, each of the waste liquid 120, biocrude oil 122, and biochar material 124 included in generated byproducts 118 may be free from and/or may not include traces of environmental contaminants 32. Filtration assembly 112 may be any suitable device, system, assembly, and/or components that may be capable of separating or filtering byproducts 118 generated by reactor 104 into each of the identified categories (e.g., 120, 122, 124) discussed herein.

System 100 may also include control system 126. Control system 126 includes elements to control the operation of system 100. More specifically, control system 126 may be in communication with each of the portions of system 100 to enable to system to perform processes for eliminating environmental contaminants 32 from biomass 10. Control system 126 may be a stand-alone system, or alternatively may be a portion and/or included in a larger computing device (not shown) of system 100. As shown in FIG. 1, control system 126 may be in electronic communication with and/or communicatively coupled to various devices, apparatuses, and/or portions of system 100. In non-limiting examples, control system 126 be hard-wired and/or wirelessly connected to and/or in communication with system 100, and its various components via any suitable electronic and/or mechanical communication component or technique. For example, control system 126 may be in electronic communication with hopper 102, reactor 104, solvent supply 106, and filtration assembly 112, respectively. Control system 126 may be in communication with each of these components or portions of system 100 to control operations and/or functions during the process, as discussed herein.

Once received in hopper 102 (and subsequently processed therein), a predetermined amount of specimens 34 of biomasses 10 may be provided to reactor 104. In a non-limiting example control system 126 may determine and/or enable hopper 102 to provide reactor 104 with the predetermined amount of specimens 34 of biomass 10. Prior to reaching reactor 104, alternatively after reaching reactor 104, specimen 34 of biomass 10 may be combined with a solvent provided by solvent supply 106. Control system 126 in communication with solvent supply 106 may enable or control solvent supply 106 to provide solvent to be combined with specimen 34 of biomass 10. The amount of solvent supplied may be dependent, at least in part on the amount of biomass 10 undergoing the processes within system 100. Additionally, or alternatively, the amount of solvent supplied and combined with biomass 10 may be dependent, at least in part, on an identified type or composition of environmental contaminant 32. That is, prior to being received in hopper 102, prior to being provided to reactor 104, or after being received by reactor 104, system 100, and more specifically control system 126, may identify, determine, and/or obtain the type or composition of environmental contaminant 32, and may subsequently determine, calculate, and/or supply a determined amount of solvent to be supplied to reactor 104 and/or combined with specimens 34 of biomass 10. In non-limiting examples, control system 126 may identify, obtain, and/or determine if environmental contaminant 32 included in biomass 10/environment 12 is polyfluoroalkyl or perfluoroalkyl substance (PFAS), ether PFAS, perfluorooctane-sulfonic acid (PFOS), perfluorooctanoic acid (PFOA), precursors to perfluoroalkyl acids (PFAAs), perfluorocarboxylic acids (PFCAs) and/or perfluorosulfonic acids (PFSAs).

Control system 126 in communication with catalyst supply 108, when included within system 100, may enable or control catalyst supply 108 to provide a catalyst material to be combined with specimen 34 of biomass 10 and/or a catalyst material. The amount of catalyst supplied may be dependent, at least in part on the amount of biomass 10 and/or the amount of solvent undergoing the processes within system 100. Additionally, or alternatively, the amount of catalyst supplied and combined with biomass 10 and the solvent material may be dependent, at least in part, on an identified type or composition of environmental contaminant 32.

Once specimen 34 of biomass 10 and the solvent material (and catalyst when applicable) are combined and positioned within the vessel forming reactor 104, control system 126 of system 100 may use reactor 104 to perform processes on the combination of biomass 10 and the solvent material under predetermined operational characteristics. For example, and as discussed herein, control system 126 may use or engage reactor 104 to pressurize and heat the combination of biomass 10 and solvent material included or disposed therein. In a non-limiting example, control system 126 may seal the vessel forming reactor 104, and ensure that the combination of biomass 10 and solvent material experience a predetermined pressure within the vessel of reactor 104. In one non-limiting example, control system 126 may maintain the predetermined pressure within reactor 104 of system 100 during the heating process discussed herein. In another non-limiting example, control system 126 may vary, change, and/or fluctuate the predetermined pressure within reactor 104 of system 100 during the heating process. The pressure, and the operation of maintaining or changing the pressure within reactor 104 during the heating process may be dependent, at least in part on, the amount of biomass 10 disposed within reactor 104, the identified type or composition of environmental contaminant 32, the concentration of environmental contaminant 32 in biomass 10/environment 12, the composition of the solvent material combined with the biomass 10, the amount of solvent material combined with the biomass 10, the composition of the catalyst material combined with the biomass 10/solvent, the amount of catalyst material combined with the biomass 10/solvent, and the like.

After the vessel forming reactor 104 is pressurized, or alternatively simultaneous to pressurizing reactor 104, control system 126 may engage heating source 110 of system 100 to heat the combination of specimens 34 of biomass 10 and the solvent material (and the catalyst material, when applicable). Similar to the pressure, control system 126 may heat the combination within reactor 104 under predetermined operational characteristics. For example, the combination of biomass 10 and the solvent material may be heated to a predetermined temperature and/or may be heated to a predetermined duration of time. The predetermined temperature and/or the predetermined duration of time may be dependent, at least partially, on the amount of biomass 10 disposed within reactor 104, the identified type or composition of environmental contaminant 32, the concentration of environmental contaminant 32 in biomass 10/environment 12, the composition of the solvent material combined with the biomass 10, the amount of solvent material combined with the biomass 10, the composition of the catalyst material combined with the biomass 10/solvent, the amount of catalyst material combined with the biomass 10/solvent, and the like. Additionally, or alternatively, the predetermined temperature and/or the predetermined duration of time may be dependent, at least partially, on the sub-critical condition or temperature of the solvent material disposed in reactor 104 and combined with biomass 10. More specifically, at least the predetermined temperature may be dependent on the sub-critical condition of the solvent material such that control system 126 and heating source 110 may never heat the solvent material above the sub-critical temperature (e.g., super critical condition or temperature) during the heating process. In a non-limiting example where the solvent is water, control system 126 may utilize reactor 104 and heating source 110 to heat the combination of solvent and biomass 10 to 300° C. for two (2) hours, under a constant pressure.

In other non-limiting examples the temperature may vary during the predetermined time. That is, during the heating process, control system 126 may activate and deactivate heating source 110 to alter, change, vary, and/or fluctuate the temperature in which the combination of biomass 10 and solvent are heated. In the non-limiting example, the varying temperature may still remain below the sub-critical condition or temperature for the solvent material.

As a result of heating and pressurizing the combination of biomass 10 and the solvent material in reactor 104, environmental contaminants 32 may be eliminated from biomass 10. More specifically, the heating and pressurization processes may remove, destroy, eliminate, and/or rid biomass 10 from environmental contaminants 32 previously absorbed from environment 12. As such, biomass 10, and the byproducts generated by system 100 from biomass 10, may be substantially free from environmental contaminants 32.

After heating and pressurizing the combination of biomass 10 and the solvent material in reactor 104, system may generate, produce, and/or create a plurality of byproducts 118. Byproducts 118 may be the matter leftover in reactor 104 after heating and pressurizing the combination, as discussed herein. Byproducts 118 may be substantially free of environmental contaminants 32, and may be used for further processing and/or within distinct systems, machines, and/or processes. In the non-limiting example, control system 126 may aid in the removal or passage of the plurality of byproducts 118 to a filtration assembly 112. Once in or provided to filtration assembly 112, control system 126 may instruct filtration assembly 112 to separate the plurality of byproducts 118 into distinct materials. In a non-limiting example, the processes discussed herein and performed by system 100 may result in the generation of waste liquid 120, biocrude oil 122, and biochar material 124. Filtration assembly 112 may be configured to filter, separate, and/or isolate each of these byproducts into individual containers for additional processing and subsequent use outside of system 100. Once completed using one batch or harvest of specimens 34 for biomass 10, a new harvest of biomass 10 may be subsequently processed using system 100, until environment 12 is clear of biomass 10 and/or all environmental contaminants 32 have been eliminated in biomasses 10/environment 12.

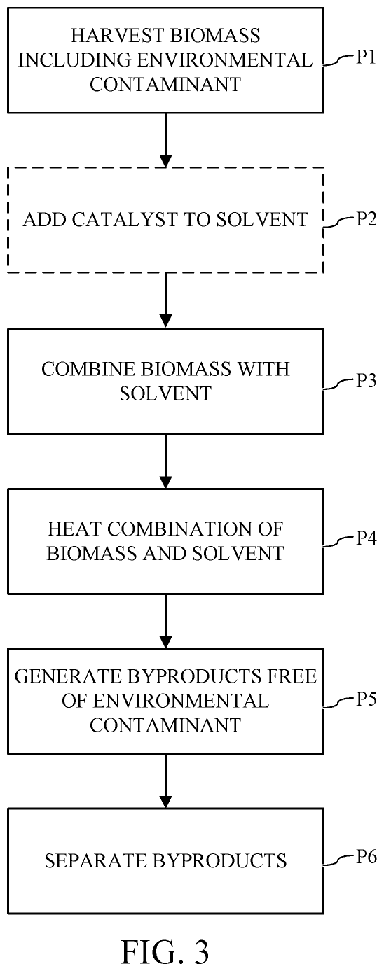

FIG. 3 depicts example processes for eliminating and destroying environmental contaminants. Specifically, FIG. 3 is a flowchart depicting one example process for eliminating environmental contaminants using biomass and portions of biomass that absorb the contaminants. In some cases, a system may be used to eliminate environmental contaminants, as discussed above with respect to FIG. 2.

In process P1, a biomass included within a environment may be harvested. Specifically, a biomass containing or included environmental contaminants absorbed from the environment may be collected and/or harvested as a specimen of the biomass for additional processing. In non-limiting examples where the biomass is a plant, the specimen harvested may include at least a portion of the shoot system and/or the root system. The biomass may absorb the environmental contaminants from the environment via a phytoremediation process. Additionally, the environmental contaminants may be any contaminant that may leech and/or be absorbed within the biomasses and/or the environment including the biomasses.

In process P2, shown in phantom as optional, a catalyst may be added to a solvent used in processing the biomass. In the non-limiting example, the catalyst may be added to the solvent before the solvent is combined with the harvest biomass (e.g., before process P3). Alternatively catalyst may be added simultaneous to the harvested biomass, along with the solvent. Still further in another non-limiting example, catalyst may be added to the combination of the harvested biomass and the solvent (e.g., after process P3).

In process P3, the harvest biomass and a solvent may be combined. That is, the harvested specimens of the biomass may be combined with a solvent material to aid in the breaking down, destruction, and/or elimination of environmental contaminants absorbed into and included within the biomass and the environment. In a non-limiting example, the harvested specimens of biomass and the solvent may be combined and subsequently disposed within a reactor of a hydrothermal liquefaction system. In another non-limiting example, the harvested specimens of biomass and the solvent may be disposed within and combined within the reactor.

In process P4, the combination of biomass and solvent (and catalyst when applicable) may be heated. More specifically, the combination of biomass and solvent may be heated, under pressure, in the reactor of the hydrothermal liquefaction system under predetermined operational characteristics. In a non-limiting example, heating the combination under the predetermined operational characteristics further includes heating the combination to a predetermined temperature, heating the combination for a predetermined duration of time, and/or maintaining a predetermined pressure within the reactor during the heating of the combination. The predetermined temperature, the predetermined duration of time, and/or the predetermined pressure may be dependent, at least in part, on the amount of biomass disposed within the reactor, the identified type or composition of the environmental contaminant absorbed by the biomass, the concentration of the environmental contaminant in the biomass 10/environment 12, the composition of the solvent material combined with the biomass, the amount of solvent material combined with the biomass, the composition of the catalyst material combined with the biomass/solvent, the amount of catalyst material combined with the biomass/solvent, and the like. Additionally, or alternatively, the predetermined temperature, the predetermined duration of time, and/or the predetermined pressure may be dependent, at least in part, on the sub-critical condition or temperature of the solvent material disposed in reactor and combined with the biomass. Heating the combination of biomass and solvent material may also include eliminating the environmental contaminants from the biomass of the environment. That is, the heating and pressurization of the combination of biomass and solvent (and catalyst when applicable) may result in the elimination, destruction, and/or removal the environmental contaminants included in the biomass.

In process P5, and as a result of heating and pressurizing the combination of biomass and solvent, a plurality of byproducts may be generated. More specifically, the heating and pressurizing of the biomass and solvent (e.g., process P4), may result in the generation, creation, and/or formation of a plurality of byproducts. Additionally, and as a result of eliminating the environmental contaminants from the biomass, the generated byproducts may be substantially free of and/or may not include any environmental contaminants previously included in the biomass.

In process P6, the plurality of byproducts may be separated. More specifically, the generated byproducts may be filtered, separated, and/or isolated from one another. For example, a filtration assembly may be used that may receive the collection or combination of the plurality of byproducts and may subsequently separate or isolate each of the plurality of byproducts for further or additional processing or uses. In non-limiting examples, the separated byproducts may include, but are not limited to, waste liquid, a biocrude oil, and/or a biochar material that may be used in subsequent and/or additional systems, machines, and/or processes.

Additional Material

Additional support and material can be found in the following publications: W. Zhang, H. Cao, & Y. Liang, Degradation by Hydrothermal Liquefaction of Fuoroalkylether Compounds Accumulated in Cattails (Typha latifolia), Journal of Environmental Chemical Engineering, 9 (2021), 1-7, W. Zhang, H. Cao, S. Mahadevan Subramanya, P. Savage, & Y. Liang, Destruction of Perfluoroalkyl Acids Accumulated in Typha latifolia Through Hydrothermal Liquefaction, ACS Sustain. Chem. Eng. 8 (2020), 9257-9262, D. Zhang, W. Zhang, & Y. Liang, Distribution of Eight Perfluoroalkyl Acids in Plant-Soil-Water Systems and Their Effect on the Soil Microbial Community, Science of Total Environment 697 (2019), 1-11, W. Zhang, D. Zhang, D. V. Zagorevski, & Y. Liang, Exposure of Juncus effusus to Seven Perfluoroalkyl Acids: Uptake, Accumulation and Phytotoxicity, Chemosphere 233 (2019) 300-308, W. Zhang & Y. Liang, Effects of Hydrothermal Treatments on Destruction of per- and polyfluoroalkyl Substances in Sewage Sludge, Environmental Pollution 285 (2021), 1-8, and W. Zhang, H. Cao, & Y. Liang, Plant Uptake and Soil Fractionation of Five ether-PFAS in Plant-Soil Systems, Science of the Total Environment, 771 (2021), 1-7. The content of the above referenced articles are hereby incorporated by reference into the present application.

The foregoing drawings show some of the processing associated according to several embodiments of this disclosure. In this regard, each drawing or block within a flow diagram of the drawings represents a process associated with embodiments of the method described. It should also be noted that in some alternative implementations, the acts noted in the drawings or blocks may occur out of the order noted in the figure or, for example, may in fact be executed substantially concurrently or in the reverse order, depending upon the act involved. Also, one of ordinary skill in the art will recognize that additional blocks that describe the processing may be added.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. “Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately” and “substantially,” are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise. “Approximately” as applied to a particular value of a range applies to both values, and unless otherwise dependent on the precision of the instrument measuring the value, may indicate +/−10% of the stated value(s).

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

What is claimed is:

1. A method comprising:
combining at least a portion of a biomass and a solvent within a reactor of a hydrothermal liquefaction system, at least the portion of the biomass having absorbed and including an environmental contaminant;
heating the combination of at least the portion of the biomass and the solvent under predetermined operational characteristics; and
generating a plurality of byproducts free of the environmental contaminant.

2. The method of claim 1, further comprising adding a catalyst to the solvent or the combination of at least the portion of the biomass and the solvent, prior to the heating and pressurizing of the combination.

3. The method of claim 2, wherein the solvent is water, and the catalyst is calcium hydroxide.

4. The method of claim 1, further comprising:
separating the plurality of byproducts into:
waste liquid;
a biocrude oil; and
a biochar material.

5. The method of claim 1, wherein heating the combination of at least the portion of the biomass and the solvent under predetermined operational characteristics further includes:
heating the combination of at least the portion of the biomass and the solvent to a predetermined temperature;
heating the combination of at least the portion of the biomass and the solvent for a predetermined duration of time; and
maintaining a predetermined pressure within the reactor of the hydrothermal liquefaction system during the heating of the combination.

6. The method of claim 5, wherein the predetermined temperature is based on at least one of a defined, sub-critical condition of the solvent and an identified type contaminant type of the environmental contaminant.

7. The method of claim 6, wherein the predetermined duration of time is based on at least one of the defined, sub-critical condition of the solvent and the identified type contaminant type of the environmental contaminant.

8. The method of claim 6, wherein the identified type of the environmental contaminants include at least one of:
at least one of a polyfluoroalkyl or a perfluoroalkyl substance (PFAS),
ether PFAS,
a perfluorooctane-sulfonic acid (PFOS),
a perfluorooctanoic acid (PFOA),
a precursor to perfluoroalkyl acids (PFAAs),
a perfluorocarboxylic acid (PFCA) or
a perfluorosulfonic acid (PFSA).

9. The method of claim 1, wherein the heating of the combination further includes:
eliminating the environmental contaminant from at least the portion of the biomass having absorbed and including the environmental contaminant.

10. The method of claim 1, wherein the biomass includes a plant, and at least the portion of the biomass includes at least part of a shoot system of the plant.

11. The method of claim 10, wherein at least the portion of the biomass includes at least part of a root system of the plant.

12. The method of claim 1, wherein at least the portion of the biomass absorbs the environmental contaminant via a Phytoremediation process.

13. A hydrothermal liquefaction system, the system comprising:
a reactor, the reactor receiving:
a solvent, and
at least a portion of a biomass having absorbed and including an environmental contaminant;
a heating source positioned within or adjacent the reactor, the heating source heating the reactor including a combination of the solvent and at least the portion of the biomass received therein; and
a control system electrically coupled to the reactor and the heating source, the control system configured to eliminate the environmental contaminant from at least the portion of the biomass by performing processes including:
heating the combination of at least the portion of the biomass and the solvent under predetermined operational characteristics via the heating source.

14. The system of claim 13, further comprising a catalyst supply in fluid communication with the reactor, the catalyst supply dispensing a catalyst to be added to the combination of at least the portion of the biomass and the solvent,
wherein the solvent is water, and the catalyst is calcium hydroxide.

15. The system of claim 13, wherein the control system is configured to eliminate the environmental contaminant from at least the portion of the biomass by performing further processes including:
generating a plurality of byproducts free of the environmental contaminant subsequent to the heating of the combination of at least the portion of the biomass and the solvent.

16. The system of claim 15, further comprising a filtration assembly in fluid communication with the reactor, the filtration assembly configured to receive and separate the plurality of byproducts into:
waste liquid;
a biocrude oil; and
a biochar material.

17. The system of claim 13, wherein heating the combination of at least the portion of the biomass and the solvent under predetermined operational characteristics further includes:
heating the combination of at least the portion of the biomass and the solvent to a predetermined temperature;
heating the combination of at least the portion of the biomass and the solvent for a predetermined duration of time; and
maintaining a predetermined pressure within the reactor of the hydrothermal liquefaction system during the heating of the combination.

18. The system of claim 17, wherein the predetermined temperature is based on at least one of a defined, sub-critical condition of the solvent and an identified type contaminant type of the environmental contaminant.

19. The system of claim 18, wherein the predetermined duration of time is based on at least one of the defined, sub-critical condition of the solvent and the identified type contaminant type of the environmental contaminant.

20. The system of claim 13, wherein the biomass includes at least one of:
at least a portion of a shoot system of a plant, or
at least a portion of a root system of the plant.
